(19) United States
(12) Patent Application Publication
(10) Pub. No.: US 2009/0157766 A1
(43) Pub. Date: Jun. 18, 2009

(54) Method, System, and Computer Program Product for Ensuring Data Consistency of Asynchronously Replicated Data Following a Master Transaction Server Failover Event

(76) Inventors: Jinmei Shen, Rochester, MN (US); Hao Wang, Rochester, MN (US)

Correspondence Address: IBM CORPORATION, 3605 HIGHWAY 52 NORTH, DEPT 917, ROCHESTER, MN, 55901-7829, US

(21) Appl. No.: 11/958,711

(22) Filed: Dec. 18, 2007

(51) Int. Cl. G06F 17/30

(52) U.S. Cl. 707/202; 707/E17.007

(57) ABSTRACT

A method, system, and computer program product for ensuring data consistency during asynchronous replication of data from a master server to a plurality of replica servers. Responsive to receiving a transaction request at the master server, recording in the plurality of replica servers a set of transaction identifiers within a replication transaction table stored in local memory of the plurality of replica servers. Responsive to receiving an acknowledgement signal from the plurality of replica servers, committing data resulting from the identified data operation within local memory of the master server. Responsive to a failover event that prevents the master server from sending a post commit signal to the at least one replica server, designating a new master server from among the plurality of replica servers. The selected replica server is associated with the replication transaction table having a fewest number of pending transaction requests.

### BACKGROUND OF THE INVENTION

1. Technical Field

The present invention relates generally to server systems and in particular to preserving data integrity in response to master transaction server failure events. More particularly, the present invention relates to a system and method for ensuring data consistency following a master transaction server failover event.

2. Description of the Related Art

A client-server network is a network architecture that separates requester or master side (i.e., client side) functionality from a service or slave side (i.e., server side functionality). For many e-business and internet business applications, conventional two-tier client server architectures are increasingly being replaced by architectures having three or more tiers in which transaction server middleware resides between client servers and large-scale backend data storage facilities. Exemplary of such multi-tier client-server system architectures are so-called high availability (HA) systems, which require access to large-scale backend data storage and highly reliable uninterrupted operability.

In one aspect, HA is a system design protocol with an associated implementation that ensures a desired level of operational continuity during a certain measurement period. In another aspect, the middleware architecture utilized in HA systems provides improved availability of services from the server side and more efficient access to centrally stored data. The scale of on-line business applications often requires hundreds or thousands of middleware transaction servers. In such a configuration, large-scale backend data storage presents a substantial throughput bottleneck. Moving most active data into middleware transaction server tiers is an effective way to reduce demand on the backend database, as well as increase responsiveness and performance.

In one such distributed request handling system, an in-memory (i.e., within local memory of transaction server) database utilizes a transactional data grid of redundant or replica transaction server and data instances for optimal scalability and performance. In this manner, transaction data retrieved and generated during processing of client requests is maintained in the distributed middle layers unless and until the transaction data is copied back to the backing store in the backend storage.

An exemplary distributed HA system architecture is illustrated in FIG. 1. Specifically, FIG. 1 illustrates an HA system 100 generally comprising multiple requesters or client servers 102a-102n and a server cluster 105 connected to a network 110. Requesters such as client servers 102a-102n send service requests to server cluster 105 via the network 110. In accordance with well-known client-server architecture principles, requests from clients 102a-102n are handled by servers within server cluster 105 in a manner providing hardware and software redundancy. For example, in the depicted embodiment, server cluster 105 comprises a master transaction server 104 and replica servers 106 and 108 configured as replicas (or replica transaction servers) of master transaction server 104. In such a configuration, data updates, such as data modify and write operations are typically processed by master transaction server 104 and copied to replica transaction servers 106 and 108 to maintain data integrity.

Redundancy protection within HA system 100 is achieved by detecting server or daemon failures and reconfiguring the system appropriately, so that the workload can be assumed by replica transaction servers 106 and 108 responsive to a hard or soft failure within master transaction server 104. All of the servers within server cluster 105 have access to persistent data storage maintained by HA backend storage device 125. Transaction log 112 is provided within HA backend storage device 125. Transaction log 112 enables failover events to be performed without losing data as a result of a failure in a master server such as master transaction server 104.

The large-scale storage media used to store data within HA backend storage 125 is typically many orders slower than local memory used to store transactional data within the individual master transaction servers and replica transaction servers within server cluster 105. Therefore, transaction data is often maintained on servers within server cluster 105 until final results data are copied to persistent storage within HA backend storage 125. If transaction log data is stored such as depicted in FIG. 1 within backend storage 125, the purpose of transaction in-memory storage is undermined. If, on the other hand, comprehensive transaction logs are not maintained, data integrity will be compromised when a master transaction server failure results in the need to switch to a replica transaction server.

Generally, there are two types of replication that can be implemented between master transaction server 104 and replica transaction servers 106 and 108: (i) synchronous replication and (ii) asynchronous replication. Synchronous replication refers to a type of data replication that guarantees zero data loss by means of an atomic write operation, whereby a write transaction to server cluster 105 is not committed (i.e., considered complete) until there is acknowledgment by both HA backend storage 125 and server cluster 105. However, synchronous replication suffers from several drawbacks. One disadvantage is that synchronous replication produces long client request times. Moreover, there is a large latency that is associated with synchronous replication. In this regard, distance can be one of several factors that can contribute to such latency.

With asynchronous replication, there is a time lag between write transactions to master transaction server 104 and write transactions of the same data to replica transaction servers 106 and 108. Under asynchronous replication, data from HA backend storage 125 is first replicated to master transaction server 104. Then, the replicated data in master transaction server 104 is replicated to replica transaction servers 106 and 108. Due to the asynchronous nature of the replication, at a certain time instance, the data stored in a database/cache of replica transaction servers 106 and 108 will not be an exact copy of the data stored in the cache/database of master transaction server 104. Thus, when a master transaction server failure event takes place during this time lag, the replica transaction server data will not be in a consistent state with the master transaction server data.

To maintain the data integrity of replica transaction servers 106 and 108 after a master transaction server failure, existing solutions reassign one of replica transaction servers 106 and 108 as a new master transaction server. Moreover, existing solutions: (i) clear all the data that are stored in the cache/database to the new master transaction server (i.e., formerly one of the replica transaction servers 106 and 108), and (ii) reload the data from HA backend storage 125 to the new master transaction server. As a result, a considerable amount of time and money is required to refill cache from HA backend storage 125. Moreover, such existing solutions of starting a new master transaction server with an empty cache is a waste of valuable time and system resources since the data difference between replica transaction server and the failed master transaction server just prior to the failover event may be a small number of transactions out of potentially millions of data records. Since many applications cache several Gigabytes of data, a considerable amount of time may be required to preload the empty cache of the new master transaction server with the replicated data. Thus, the value of distributed cache becomes diminished.

### SUMMARY OF AN EMBODIMENT

A method, system, and computer program product for ensuring data consistency during asynchronous replication of data from a master transaction server to a plurality of replica transaction servers are disclosed herein. Responsive to receiving a transaction request (e.g., write/modify request) at a master transaction server, a set of transaction identifiers within a replication transaction table is concurrently stored in the local memory of each one of a plurality of replica transaction servers. The set of transaction identifiers identify a data operation specified by the received transaction request and enables one of the plurality of replica transaction servers to recover handling requests in response to a failover event. The set of transaction identifiers includes one or more of a log sequence number (LSN), a transaction identification (ID) number, and a key type. Data resulting from the identified data operation is committed within local memory of the master transaction server. Responsive to completion of committing the data within the master transaction server local memory, a post commit signal with transactional log sequences is asynchronously sent to the at least one replica transaction server. Data resulting from the identified data operation is also committed within local memory of the at least one replica transaction server. Responsive to a failover event that prevents the master transaction server from sending the post commit signal or log sequences have not arrived at replicas or replicas have not applied log sequences, a new master transaction server is selected from among the plurality of replica transaction servers. The selected replica transaction server is associated with the replication transaction table having a fewest number of pending transaction requests.

The above, as well as additional features of the present invention will become apparent in the following detailed written description.

### BRIEF DESCRIPTION OF THE DRAWINGS

The invention will best be understood by reference to the following detailed description of an illustrative embodiment when read in conjunction with the accompanying drawings, wherein:

FIG. 1 is a high-level block diagram illustrating the general structure and data storage organization of a high availability system according to the prior art;

FIG. 2 is a high-level block diagram depicting a high availability server system adapted to implement failover replication data handling in accordance with the present invention;

FIG. 3 is a block diagram depicting a data processing system that may be implemented as a server in accordance with an embodiment of the present invention;

FIG. 4 is a block diagram illustrating a data processing system in which the present invention may be implemented;

FIG. 5 is a high-level flow diagram of exemplary method steps illustrating master-side replication data handling in accordance with the present invention; and

FIGS. 6A and 6B represent portions of a high-level flow diagram of exemplary method steps illustrating replica-side replication and failover data handling in accordance with the present invention.

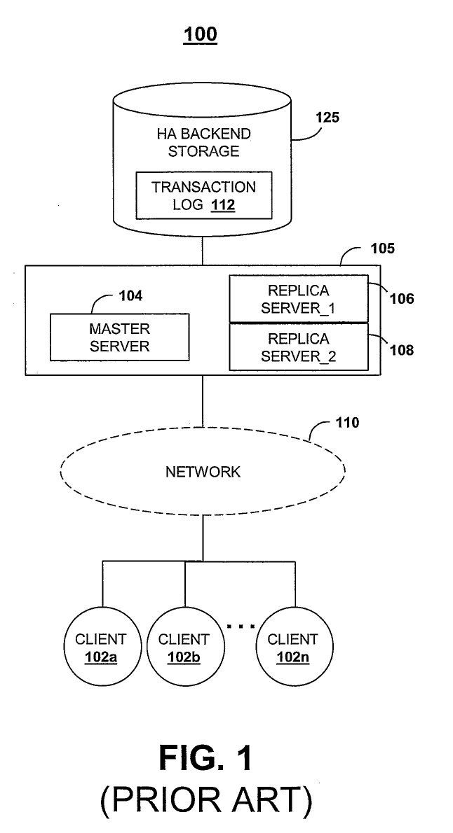

### DETAILED DESCRIPTION OF ILLUSTRATIVE EMBODIMENT(S)

The present invention is directed to a method, system, and computer program product for ensuring data consistency during asynchronous replication of data from a master transaction server to a plurality of replica transaction servers.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

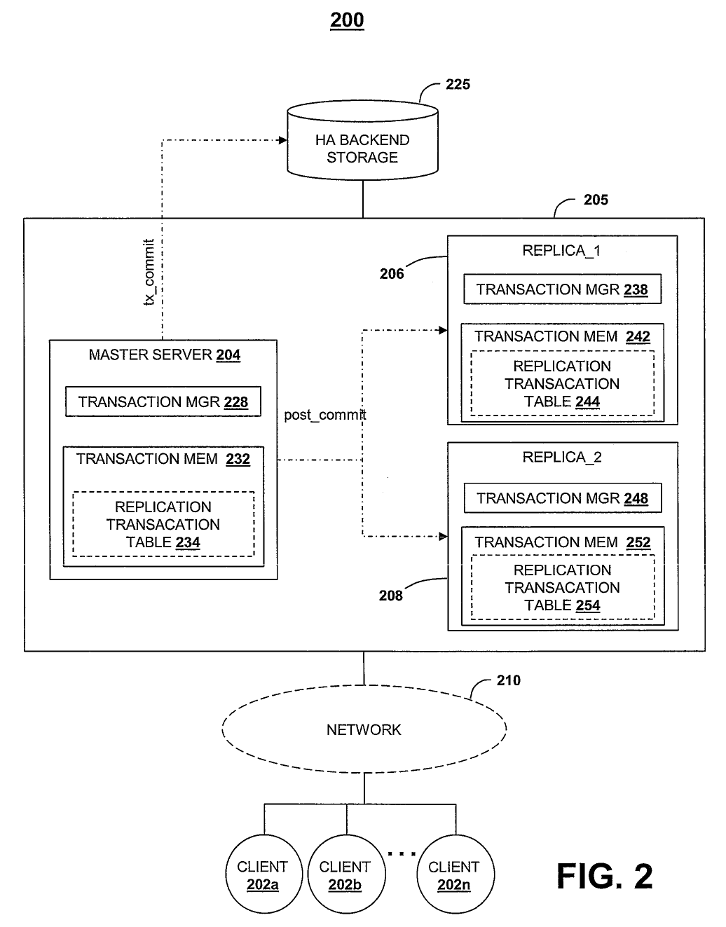

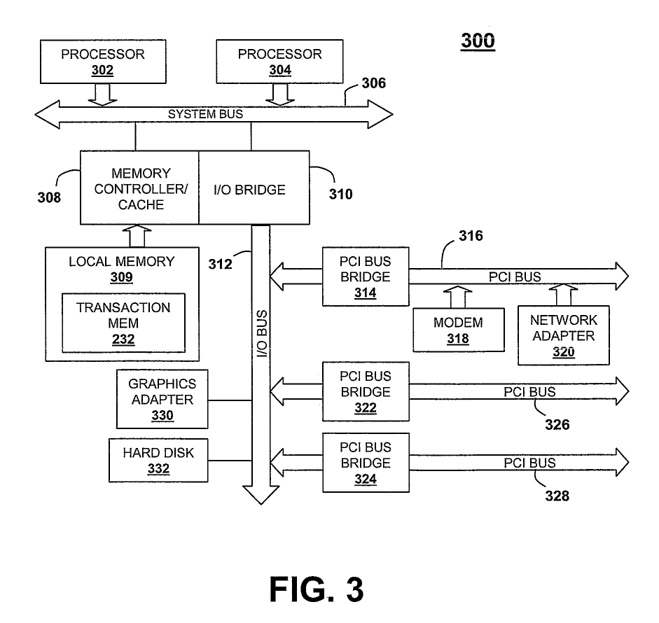

Within the descriptions of the figures, similar elements are provided similar names and reference numerals as those of the previous figure(s). Where a later figure utilizes the element in a different context or with different functionality, the element is provided a different leading numeral representative of the figure number (e.g., 2xx for FIG. 2 and 3xx for FIG. 3). The specific numerals assigned to the elements are provided solely to aid in the description and not meant to imply any limitations (structural or functional) on the invention.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized.

FIG. 2 is a high-level block diagram depicting a high-availability (HA) server system 200 adapted to implement failover data handling in accordance with the present invention. As shown in FIG. 2, HA server system 200 generally comprises multiple client servers 202a-202n communicatively coupled to server cluster 205 via network 210. In the depicted configuration, client servers 202a-202n send data transaction requests to server cluster 205 via network 210. Server cluster 205 may be a proxy server cluster, web server cluster, or other server cluster that includes multiple, replication configured servers for handling high traffic demand. The replication configuration enables transaction requests from clients 202a-202n to be handled by server cluster 205 in a manner providing hardware and software redundancy.

In the depicted embodiment, server cluster 205 includes master transaction server 204 and replication transaction servers 206 and 208 configured as replicas of master transaction server 204. In such a configuration, data updates, such as data modify and write operations are, by default, exclusively handled by master transaction server 204 to maintain data integrity and consistency between master transaction server 204 and backend storage device 225. Redundancy and fault tolerance are provided by replica transaction servers 206 and 208 which maintain copies of data transactions handled by and committed within master transaction server 204.

HA server system 200 is configured as a three-tier data handling architecture in which server cluster 205 provides intermediate data handling and storage between client servers 202a-202n and backend data storage device 225. Such network accessible data distribution results in a substantial portion of client request transaction data being maintained in the “middle” layer comprising server cluster 205 to provide faster access and alleviate the data access bottleneck that would otherwise arise from direct access to backend data storage device 225.

In a further aspect, the three-tier architecture of HA server system 200 implements asynchronous transaction data replication among master transaction server 204 and replica transaction servers 206 and 208. In this manner, locally stored data in master transaction server (i.e., data stored on the local memory devices within the master transaction server) are replicated to replica transaction servers 206 and 208 in an asynchronous manner. The asynchronous data replication implemented with server cluster 205 provides redundancy and fault tolerance by detecting server or daemon failures and reconfiguring the system appropriately, so that the workload can be assumed by replica transaction servers 206 and 208 responsive to a hard or soft failure within master transaction server 204.

FIG. 2 further depicts functional features and mechanisms for processing transaction requests in the distributed data handling architecture implemented by HA server system 200. In the depicted embodiment, the distributed transaction log is embodied by transaction manager components contained within master transaction server 204 and replica transaction servers 206 and 208. Namely, master transaction server 204 includes transaction manager 228 and replica transaction servers 206 and 208 include transaction managers 238 and 248, respectively. Transaction managers 228, 238, and 248 process client transaction requests (e.g., write/modify requests) in a manner ensuring failover data integrity while avoiding the need to access a centralized transaction log within backend storage device 225 or to maintain excessive redundancy data.

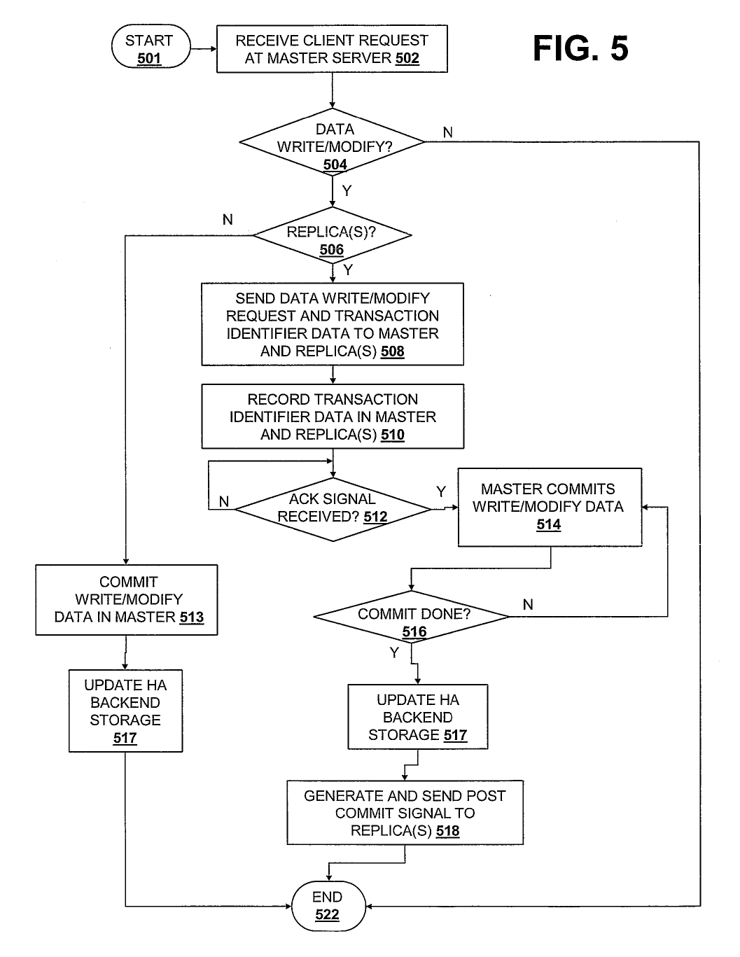

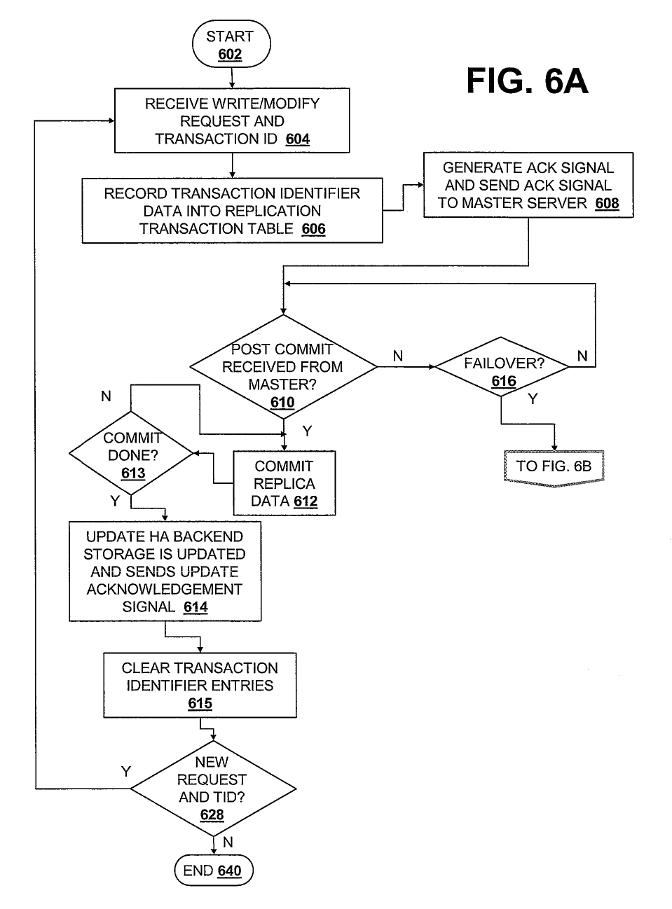

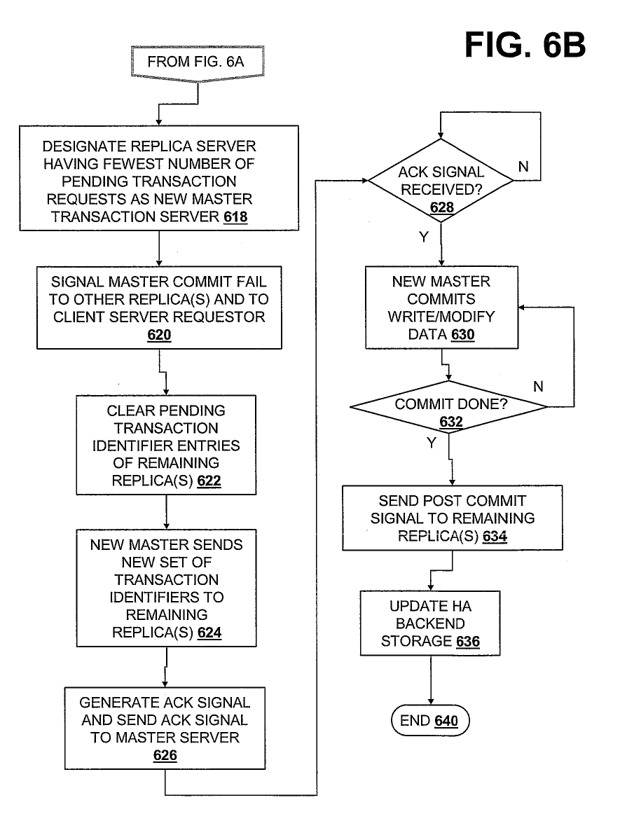

Each of the transaction managers within the respective master and replica servers manage transaction status data within locally maintained transaction memories. In the depicted embodiment, for example, transaction managers 228, 238, and 248 maintain replication transaction tables 234, 244, and 254, respectively. Replication transaction tables 234, 244, and 254 are maintained within local transaction memory spaces 232, 242, and 252, respectively. As illustrated and explained in further detail below with reference to FIGS. 5-6, the transaction managers generate and process transaction identifier data, such as in the form of log sequence numbers (LSNs), transaction identification (ID) numbers, and data keys, in a manner enabling efficient failover handling without compromising data integrity.

Client transaction request processing is generally handled within HA server system 200 as follows. Client transaction requests are sent from client servers 202a-202n to be processed by the master/replica transaction server configuration implemented by server cluster 205. A transaction request may comprise a high-level client request such as, for example, a request to update bank account information which in turn may comprise multiple lower-level data processing requests such as various data reads, writes or modify commands required to accommodate the high-level request. As an example, client server 202a may send a high-level transaction request addressed to master transaction server 204 requesting a deposit into a bank account having an account balance, ACCT_BAL1, prior to the deposit transaction. To satisfy the deposit request, the present account balance value, ACCT_BAL1, is modified to a different amount, ACCT_BAL2, in accordance with the deposit amount specified by the deposit request. If the data for the bank account in question has been recently loaded and accessed, the present account balance value, ACCT_BAL1, may be stored in the local transaction memory 232 of master transaction server 204, as well as the local memories 242 and 252 of replica transaction servers 206 and 208 at the time the account balance modify transaction request is received. Otherwise, the account balance value, ACCT_BAL1, may have to be retrieved and copied from backend storage device 225 into the local memory of master transaction server 204. The account balance value, ACCT_BAL1 is then retrieved and copied from the local memory of master transaction server 204 to the local memories of replica transaction server servers 206 and 208, in accordance with asynchronous replication.

The received deposit request is processed by master transaction server 204. Responsive to initially processing the received deposit request, but before committal of one or more data results, master transaction server 204 issues transaction identifier data (i.e., LSN, transaction ID number, and/or data keys) to local transaction memory 232, and to local transaction memories 242 and 252 of replica transaction servers 206 and 208, respectively. Master transaction server 204 and each replica transaction server 206 and 208 record the transaction identifier data in replication transaction tables 234, 244, and 254, respectively. Before master transaction server 204 commits the requested transaction, master transaction server 204 waits for an acknowledgement (ACK) signal from each replica transaction server 206 and 208. The ACK signal signals to master transaction server 204 that transaction managers 238 and 248 of replica transaction servers 206 and 208 have received the transaction identifier data associated with the pending transaction to be committed in master transaction server 204. Upon receipt of the ACK signal, master transaction server 204 commences commitment of the transaction data (i.e., modifying the stored ACCT_BAL1 value to the ACCT_BAL2 value). After master transaction server 204 has finished committing the transaction, master transaction server 204 generates a post-commit signal, and sends the post-commit signal to replica transaction servers 206 and 208. Upon receipt of the post-commit signal, replica transaction servers 206 and 208 commence committal of the pending transaction. In addition, master transaction server sends the transaction data to update backend storage 225. Once backend storage 225 has been updated, backend storage 225 sends an update acknowledgment signal to master transaction server 204.

Committing of the resultant data is performed in an asynchronous manner such that committing the data within replica transaction servers 206 and 208 is performed once the data is committed within master transaction server 204. Following commitment of data within master transaction server 204 and replica transaction servers 206 and 208, master transaction server 204 copies back the modified account balance data to backend storage device 225 using a transaction commit command, tx_commit, to ensure data consistency between the middleware storage and persistent backend storage. After master transaction server 204 receives the update acknowledgement signal from backend storage 225, master transaction server 204 and replica transaction servers 206 and 208 respectively clear the corresponding transaction identifier data entries within replication transaction tables 234, 244, and 254.

Referring to FIG. 3, there is illustrated a block diagram of a server system 300 that may be implemented as one or more of servers 204, 206, and 208 within server cluster 205 in FIG. 2, in accordance with the invention. Server system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. Local memory 309 includes local transaction memory of the various servers (e.g., local transaction memory 232 of master transaction server 204, local transaction memory 242 of replica transaction server 206 or local transaction memory 252 of replica transaction server 208). I/O bus bridge 310 is connected to system bus 306 and provides an interface to I/O bus 312. Memory controller/cache 308 and I/O bus bridge 310 may be integrated as depicted.

Peripheral component interconnect (PCI) bus bridge 314 connected to I/O bus 312 provides an interface to PCI local bus 316. A number of modems 318 may be connected to PCI local bus 316. Typical PCI bus implementations will support four PCI expansion slots or add-in connectors. Communications links to client servers 202a-202n in FIG. 2 may be provided through modem 318 and network adapter 320 connected to PCI local bus 316 through add-in connectors.

Additional PCI bus bridges 322 and 324 provide interfaces for additional PCI local buses 326 and 328, from which additional modems or network adapters may be supported. In this manner, data processing system 300 allows connections to multiple network computers. Memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention. The data processing system depicted in FIG. 3 may be, for example, an IBM System p5™ (a trademark of International Business Machines—IBM), a product of International Business Machines (IBM) Corporation in Armonk, N.Y., running the Advanced Interactive Executive (AIX®) operating system, a registered trademark of IBM, Microsoft Windows® operating system, a registered trademark of Microsoft Corp., or GNU®/Linux® operating system, registered trademarks of the Free Software Foundation and Linus Torvalds.

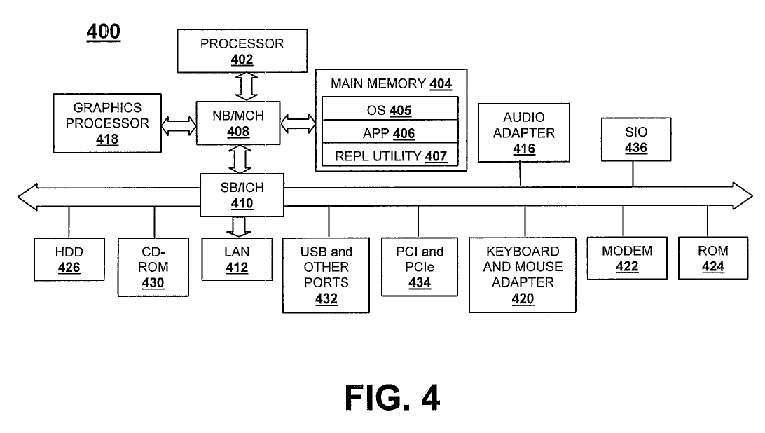

With reference now to FIG. 4, a block diagram of data processing system 400 is shown in which features of the present invention may be implemented. Data processing system 400 is an example of a computer, such as one of a server within server cluster 205 and/or one or more of client servers 202a-202n in FIG. 2, in which code or instructions implementing the processes of the present invention may be stored and executed. In the depicted example, data processing system 400 employs a hub architecture including a north bridge and memory controller hub (MCH) 408 and a south bridge and input/output (I/O) controller hub (SB/ICH) 410. Processor 402, main memory 404, and graphics processor 418 are connected to MCH 408. Graphics processor 418 may be connected to the MCH 408 through an accelerated graphics port (AGP), for example.

In the depicted example, LAN adapter 412, audio adapter 416, keyboard and mouse adapter 420, modem 422, read only memory (ROM) 424, hard disk drive (HDD) 426, CD-ROM driver 430, universal serial bus (USB) ports and other communications ports 432, and PCI/PCIe devices 434 may be connected to SB/ICH 410. PCI/PCIe devices may include, for example, Ethernet adapters, add-in cards, PC cards for notebook computers, etc. ROM 424 may include, for example, a flash basic input/output system (BIOS). Hard disk drive 426 and CD-ROM drive 430 may use, for example, an integrated drive electronics (IDE) or serial advanced technology attachment (SATA) interface. Super I/O (SIO) device 436 may be connected to SB/ICH 410.

Notably, in addition to the above described hardware components of data processing system 400, various features of the invention are completed via software (or firmware) code or logic stored within main memory 404 or other storage (e.g., hard disk drive (HDD) 426) and executed by processor 402. Thus, illustrated within main memory 404 are a number of software/firmware components, including operating system (OS) 405 (e.g., Microsoft Windows® or GNU®/Linux®), applications (APP) 406, and replication (REPL) utility 407. OS 405 runs on processor 402 and is used to coordinate and provide control of various components within data processing system 400. An object oriented programming system, such as the Java® (a registered trademark of Sun Microsystems, Inc.) programming system, may run in conjunction with OS 405 and provides calls to OS 405 from Java® programs or APP 406 executing on data processing system 400. For simplicity, REPL utility 407 is illustrated and described as a stand alone or separate software/firmware component, which provides specific functions, as described below.

Instructions for OS 405, the object-oriented programming system, APP 406, and/or REPL utility 407 are located on storage devices, such as hard disk drive 426, and may be loaded into main memory 404 for execution by processor 402. The processes of the present invention may be performed by processor 402 using computer implemented instructions, which may be stored and loaded from a memory such as, for example, main memory 404, ROM 424, HDD 426, or in one or more peripheral devices (e.g., CD-ROM 430).

Among the software instructions provided by REPL utility 407, and which are specific to the invention, are: (a) responsive to receiving a transaction request at the master transaction server, recording in a plurality of replica transaction servers a set of transaction identifiers, wherein said set of transaction identifiers identify a data operation specified by the received transaction request and enables one of said plurality of replica transaction servers to recover handling requests in response to a failover event; (b) responsive to receiving an acknowledgement (ACK) signal from the plurality of replica transaction servers, committing data resulting from the identified data operation within local memory of the master transaction server; and (c) responsive to completing the committing data within the master transaction server's local memory, sending a post commit signal to the plurality of replica transaction servers, wherein the post commit signal commits data resulting from the identified data operation within local memory of at least one of the plurality of replica transaction servers.

For simplicity of the description, the collective body of code that enables these various features is referred to herein as REPL utility 407. According to the illustrative embodiment, when processor 402 executes REPL utility 407, data processing system 400 initiates a series of functional processes that enable the above functional features as well as additional features/functionality, which are described below within the description of FIGS. 5-6B.

Those of ordinary skill in the art will appreciate that the hardware in FIG. 4 may vary depending on the implementation. Other internal hardware or peripheral devices, such as flash memory, equivalent non-volatile memory, or optical disk drives and the like, may be used in addition to or in place of the hardware depicted in FIG. 4. Also, the processes of the present invention may be applied to a multiprocessor data processing system such as that described with reference to FIG. 3.

FIG. 5 is a high-level flow diagram illustrating master-side replication data handling such as may be implemented by master transaction server 204 within HA server system 200 in accordance with the present invention. The process begins as illustrated at step 501 and proceeds to step 502 with master transaction server 204 receiving a client request such as from one of client servers 202a-202n of FIG. 2. In response to determining at step 504 that the client request does not require some modification or writing of data, such as for a read request, no replication data handling is necessary and the process continues to step 513. At step 513, the transaction is committed in master transaction server 204. From step 513, the data in HA backend storage 225 is updated, as depicted in step 517. The process ends as shown at step 522. The process also terminates without replication data handling if it is determined at step 504 that the client request is a data write and/or modify request, and server cluster only has a master transaction server 204 and does not include any replica transaction servers (step 506).

If it is determined at step 504 that the client request is a data write and/or modify request and at step master transaction server 204 is presently configured with replica transaction servers, such as replica transaction servers 206 and 208 of FIG. 2, (step 506), the process continues as shown at step 508 with master transaction server 204 concurrently sending (i) write/modify request(s), and (ii) transaction identifier data (i.e., LSN, transaction ID number, and/or data keys) to local transaction memory 232, and to local transaction memories 242 and 252 of replica transaction servers 206 and 208 of FIG. 2, respectively. The transaction identifier data is recorded in replication transaction tables 234, 244, and 254 of FIG. 2, as depicted in step 510.

Before master transaction server 204 commits the requested transaction (step 514), master transaction server 204 waits for receipt of an ACK signal from each replica transaction server 206 and 208 (decision step 512). After the ACK signal is received by master transaction server 204, the process continues to step 514 with the write/modify data being committed to local memory (i.e., a local memory device such as an onboard random access memory (RAM) device) within master transaction server 204 (refer also to local memory 309 of FIG. 3). As utilized herein, committing data refers to copying, writing, or otherwise storing the subject data within physical local memory of the server, in this case master transaction server 204. Committing of the data to the local memory within master transaction server 204 continues as shown in step 514 until a determination is made at decision step 516 that the data commit is complete. Responsive to determining in decision step 516 that the data commit is complete, the process continues to step 517, where HA backend storage 225 is updated with the new data that is generated in master transaction server 204. From step 517, master transaction server 204 generates a post commit signal or message with transactional log sequences and asynchronously sends the signal to presently configured replica transaction servers 206 and 208 (step 518). From block 518, master-side replication transaction processing terminates as shown at step 522.

FIGS. 6A and 6B represent portions of a high-level flow diagram illustrating the exemplary process steps used to implement and utilize the method of replica-side replication and failover data handling in accordance with the present invention. Referring now to FIG. 6A, the process begins as shown at step 602 and continues to step 604 with one or both of replica transaction servers 206 and/or 208 receiving a write/modify request and corresponding transaction identifier from master transaction server 204 of FIG. 2. The write/modify request specifies data to be committed to local replica memories 242 and 252 of FIG. 2 and the transaction identifier specifies the one or more data operations required to commit the data to local memory. In one embodiment, the transaction identifier(s) comprise(s) one or more: log sequence numbers (LSNs), transaction identification (ID) numbers, and data keys. As used herein, an LSN is a unique identification for a log record that facilitates log recovery. Most LSNs are assigned in monotonically increasing order, which is useful in data recovery operations. A transaction ID number is a reference to the transaction generating the log record. Data keys correspond to a specified data item specified by the transaction request received by master transaction server 204.

Responsive to receiving the transaction identifier(s) from master transaction server 204, replica transaction servers 206 and 208 record the received transaction identifier(s) to replication transaction tables 244 and 254 of FIG. 2, respectively (step 606). Replication transaction tables 244 and 254 are maintained and located within local memories 242 and 252, respectively (i.e., physical memory devices such as RAM devices within the replica transaction servers). After receiving the transaction identifier(s) from master transaction server 204, replica transaction servers 206 and 208 generate ACK signal and send ACK signal to master transaction server 204, as depicted in step 608.

Once the ACK signal has been sent to master transaction server 204, the method continues to decision step 610 in which a determination is made whether a post commit signal is received by replica transaction servers 206 and 208 from master transaction server 204. Responsive to receiving a post commit signal from master transaction server 204, replica transaction servers 206 and 208 commence committing the subject data to their respective local memories 242 and 252, as depicted in step 612. A determination is then made whether the commitment of subject data in local memories 242 and 252 has been completed, as depicted in decision step 613. If commitment of subject data has not been completed, the replica data continues to be committed to replica transaction server local memory (step 612) until the commitment is completed. Once the commitment of replica data locally within replica transaction servers 206 and 208 is complete, (i) backend storage 225 is updated with data committed in master transaction server 204 and (ii) backend storage 225 sends an update acknowledgment signal to master transaction server 204, as depicted in step 614. Once the update acknowledgement signal is received, the corresponding transaction identifier entries (e.g., data keys) within the replication transaction tables 244 and 254 are cleared (step 615). After clearing the transaction identifier entries, a determination is made whether a next write/modify request and associated transaction identifier is received, as depicted in decision step 628. If no other write/modify request and associated transaction identifier (TID) is received, the method terminates as shown at step 640.

As shown at steps 610 and 616, replica transaction servers 206 and 208 wait for the post commit signal unless and until a failover event is detected and no post commit has been received. A failover event generally constitutes a failure that interrupts processing by master transaction server 204. Examples of failover events include: a physical or logical server failure, physical or logical network/connectivity failure, master transaction server overload, and the like. At decision step 616, a determination is made whether a failover event has occurred at master transaction server 204. In this regard, a timeout period or other trigger may be implemented to trigger said determination in the event that a post-commit signal has not been received within the timeout period. From decision step 616, the process continues in FIG. 6B.

Referring now to FIG. 6B, responsive to detecting a failover event, one of replica transaction servers 206 and 208 is designated as the new master transaction server, as depicted in step 618. The new master transaction server is associated with the replication transaction table 244 and/or 254 having the fewest number of pending transaction requests. A replica transaction server having the fewest number of pending transaction requests indicates that the particular replica transaction server contains the most updated data. As a result, less processing is needed to synchronize the data stored in the new master transaction server (formerly replica transaction server 206 or 208) with the data committed in the original master transaction server 204 before the failover event.

When the new master transaction server is designated, the new master transaction server will have at least one transaction identifier for which data must be generated in order to satisfy the pending transaction. At the same time, the remaining replica transaction servers may have pending transaction requests in addition to the transaction requests that are pending in the new master transaction server. From step 618, the new master transaction server will signal to the remaining replica transaction servers that a failover event (or master commit fail) has occurred and that the new master transaction server is now the de facto master transaction server, as depicted in step 620. In addition, the new master transaction server notifies the client server requestor of the master commit fail. From step 620, the new master transaction server will send a request to clear the transaction identifier entries that are still pending in remaining replica server(s), as depicted in step 622. New master transaction server sends a new set of transaction identifiers to remaining replica(s), as depicted in step 624. ACK signal is generated and sent by remaining replica transaction servers to the new master transaction server, as depicted in step 626. ACK signal acknowledges receipt by remaining replica transaction servers of new set of transaction identifiers.

Once ACK signal is received from the remaining replica transaction servers, the new master transaction server (decision step 628), the new master transaction server commits the write/modify data associated with the pending transaction request, as depicted in step 630. After it is determined that the write/modify data has been committed in new master transaction server (decision step 632), the new master transaction server sends a post commit signal to remaining replica transaction server(s), as depicted in step 634. From step 634, the new master transaction server sends committed data to HA backend storage 225. From this point, the new master transaction server commences handling requests as the de factor master server using the procedure illustrated and described with reference to FIG. 5. The process ends at terminator step 640.

In the flow charts above (FIGS. 5, 6A, and 6B), one or more of the methods are embodied as a computer program product in a computer readable medium or containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the methods in embodiments of the present invention may be implemented using any combination of software, firmware, or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture (or computer program product) in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a computer program product in a variety of forms, and that an illustrative embodiment of the present invention applies equally regardless of the particular type of media used to actually carry out the distribution. By way of example, a non exclusive list of types of media includes recordable type (tangible) media such as floppy disks, thumb drives, hard disk drives, CD ROMs, DVD ROMs, and transmission type media such as digital and analog communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for ensuring data consistency during asynchronous replication of data from a master transaction server to a plurality of replica transaction servers, said method comprising:
responsive to receiving a transaction request at the master transaction server, recording in the plurality of replica transaction servers a set of transaction identifiers, wherein said set of transaction identifiers identify a data operation specified by the received transaction request and enables one of said plurality of replica transaction servers to recover handling requests in response to a failover event;
responsive to receiving an acknowledgement (ACK) signal from the plurality of replica transaction servers, committing data resulting from the identified data operation within local memory of the master transaction server; and
responsive to completing said committing data within the master transaction server's local memory, sending a post commit signal to the plurality of replica transaction servers, wherein the post commit signal commits data resulting from the identified data operation within local memory of at least one of the plurality of replica transaction servers.

2. The method of claim 1, further comprising:
responsive to a failover event that prevents the master transaction server from sending the post commit signal to the at least one of said plurality of replica transaction servers, designating a new master transaction server from among the plurality of replica transaction servers, wherein the selected replica transaction server is associated with a replication transaction table having a fewest number of pending transaction requests.

3. The method of claim 1, wherein said set of transaction identifiers includes at least one of a log sequence number (LSN), a transaction identification (ID) number, and a key type.

4. The method of claim 2, further comprising:
responsive to designating the new master transaction server:
signaling a master commit fail to at least one remaining replica transaction server and to a client server requester;
clearing pending transaction identifier entries of the at least one remaining replica transaction server; and
sending a new set of transaction identifiers to the at least one remaining replica transaction server.

5. The method of claim 1, wherein said recording step records within said replication transaction table stored in local memory of the plurality of replica transaction servers.

6. A system for ensuring data consistency during asynchronous replication of data from a master transaction server to a plurality of replica transaction servers, said system comprising:
a processor;
a memory coupled to the processor; and
a replication (REPL) utility executing on the processor for providing the functions of:
responsive to receiving a transaction request at the master transaction server, recording in the plurality of replica transaction servers a set of transaction identifiers, wherein said set of transaction identifiers identify a data operation specified by the received transaction request and enables one of said plurality of replica transaction servers to recover handling requests in response to a failover event;
responsive to receiving an acknowledgement (ACK) signal from the plurality of replica transaction servers, committing data resulting from the identified data operation within local memory of the master transaction server; and
responsive to completing said committing data within the master transaction server's local memory, sending a post commit signal to the plurality of replica transaction servers, wherein the post commit signal commits data resulting from the identified data operation within local memory of at least one of the plurality of replica transaction servers.

7. The system of claim 6, the REPL utility further having executable code for:
responsive to a failover event that prevents the master transaction server from sending the post commit signal to the at least one of said plurality of replica transaction servers, designating a new master transaction server from among the plurality of replica transaction servers, wherein the selected replica transaction server is associated with a replication transaction table having a fewest number of pending transaction requests.

8. The system of claim 6, wherein said set of transaction identifiers includes at least one of a log sequence number (LSN), a transaction identification (ID) number, and a key type.

9. The system of claim 7, the REPL utility further having executable code for:
responsive to designating the new master transaction server:
signaling a master commit fail to at least one remaining replica transaction server and to a client server requester;
clearing pending transaction identifier entries of the at least one remaining replica transaction server; and
sending a new set of transaction identifiers to the at least one remaining replica transaction server.

10. The system of claim 6, wherein said recording step records within said replication transaction table stored in local memory of the plurality of replica transaction servers.

11. A computer program product comprising:
a computer readable medium; and
program code on the computer readable medium that when executed by a processor provides the functions of:
responsive to receiving a transaction request at the master transaction server, recording in the plurality of replica transaction servers a set of transaction identifiers, wherein said set of transaction identifiers identify a data operation specified by the received transaction request and enables one of said plurality of replica transaction servers to recover handling requests in response to a failover event;
responsive to receiving an acknowledgement (ACK) signal from the plurality of replica transaction servers, committing data resulting from the identified data operation within local memory of the master transaction server; and
responsive to completing said committing data within the master transaction server's local memory, sending a post commit signal to the plurality of replica transaction servers, wherein the post commit signal commits data resulting from the identified data operation within local memory of at least one of the plurality of replica transaction servers.

12. The computer program product of claim 11, further comprising code for:
responsive to a failover event that prevents the master transaction server from sending the post commit signal to the at least one of said plurality of replica transaction servers, designating a new master transaction server from among the plurality of replica transaction servers, wherein the selected replica transaction server is associated with a replication transaction table having a fewest number of pending transaction requests.

13. The computer program product of claim 11, wherein said set of transaction identifiers includes at least one of a log sequence number (LSN), a transaction identification (ID) number, and a key type.

14. The computer program product of claim 12, further comprising code for:
responsive to designating the new master transaction server:
signaling a master commit fail to at least one remaining replica transaction server and to a client server requester;
clearing pending transaction identifier entries of the at least one remaining replica transaction server; and
sending a new set of transaction identifiers to the at least one remaining replica transaction server.

15. The computer program product of claim 11, wherein said recording step records within said replication transaction table stored in local memory of the plurality of replica transaction servers.
